(19) United States
(12) Patent Application Publication
(10) Pub. No.: US 2012/0075326 A1
(43) Pub. Date: Mar. 29, 2012

(54) BACKLIGHT DEVICE AND LIQUID CRYSTAL DISPLAY DEVICE

(75) Inventors: Ryuji TSUCHIYA, EHIME-KEN (JP); Shota IKEBE, EHIME-KEN (JP)

(73) Assignee: HARISON TOSHIBA LIGHTING Corp., IMABARI-SHI (JP)

(21) Appl. No.: 13/235,831

(22) Filed: Sep. 19, 2011

(30) Foreign Application Priority Data
Sep. 27, 2010 (JP) 2010-215008

(51) Int. Cl. G09G 5/02; F21V 7/00; G02F 1/1335; G09F 13/04

(52) U.S. Cl. 345/589; 362/613; 362/609; 349/65

(57) ABSTRACT

According to an embodiment, a backlight device includes a plurality of light guide plates, a plurality of light sources and a light-source substrate. The light guide plates overlap each other with a same light output direction; each of the light guide plates includes a plurality of stripe-shaped projections aligned on a light output face and a light output pattern. Each of the light sources emits light incident into any one of the light guide plates and propagating in an extending direction of the stripe-shaped projections. The light-source substrate includes a plurality of interconnections, a turning-on signal is selectively supplied via the interconnections to at least one of light source groups, and each of the light source groups includes at least one of the light sources. At least one part of a light emission face, including the light output faces, emits light output from the light source group receiving the turning-on signal.

### CROSS-REFERENCE TO RELATED APPLICATIONS

This application is based upon and claims the benefit of priority from Japanese Patent Application No. 2010-215008, filed on Sep. 27, 2010; the entire contents of which are incorporated herein by reference.

### FIELD

The present invention is related to a backlight device and a liquid crystal display device.

### BACKGROUND

Recently, local dimming (area control) has been employed in liquid crystal display devices, in which brightness of a display screen is locally dimmed in accordance with brightness information of an image. For example, suppressing brightness of a portion, where a dark image is displayed, may improve contrast in the display screen and reduce power consumption.

Local dimming is effectively realized by using a direct type backlight, in which a plurality of light emitting diodes (LED) are arranged in a two-dimensional manner corresponding to the display screen and the LED is easily controlled to be locally turned on. On the other hand, a sidelight type backlight is considered not to be suitable for the local dimming, where thinner device and uniform light emission are required. In the sidelight type backlight, light sources are arranged on the side face of a light guide plate and the light incident into the light guide plate propagates not only in the optical axis direction but also in an angular direction. Therefore, it is difficult for the sidelight type backlight to control brightness of a desired light emission region.

Japanese Unexamined Patent Application Publication No. 2008-117730 describes a sidelight type planar light-source device in which two guide light plates having different light emission regions are combined in order to suppress color unevenness on the display screen. However, this device does not have a configuration intended for local dimming in the display screen.

In the liquid crystal display device provided with a sidelight type back light, if a bright image is to be displayed at the center of the screen and a dark image is displayed in the periphery, for example, a dark image in the periphery may be displayed by throttling the aperture ratio of the liquid crystal. However, contrast cannot be improved better than the limit of the throttle value of the liquid crystal, and power consumption cannot be also reduced in this method. Thus, it is demanded for a sidelight type backlight device with thinner thickness to effectively execute the local dimming.

### SUMMARY

According to an embodiment, a backlight device includes a plurality of light guide plates, a plurality of light sources and a light-source substrate. The light guide plates overlap each other with a same light output direction, each of the light guide plates includes a plurality of stripe-shaped projections aligned on a light output face and a light output pattern making a part of the light output face emit light at relatively high brightness. Each of the light sources emits light incident into any one of the light guide plates and propagating in an extending direction of the stripe-shaped projections. The light-source substrate includes a plurality of interconnections, a turning-on signal is selectively supplied via the interconnections to at least one of light source groups, and each of the light source groups includes at least one of the light sources. At least one part of a light emission face, including the light output faces overlapped on plan view from the light output direction, emits light output from the light source group receiving the turning-on signal.

### BRIEF DESCRIPTION OF THE DRAWINGS

FIG. 1 is a schematic diagram illustrating a liquid crystal display device according to a first embodiment;

FIG. 2 is a schematic plan view illustrating a backlight according to the first embodiment;

FIG. 3A is a schematic cross-sectional view illustrating the backlight according to the first embodiment, and FIGS. 3B and 3C are schematic views illustrating planar arrangements of light sources on a light-source substrate;

FIG. 4 is a schematic cross-sectional view illustrating a backlight according to a variation of the first embodiment;

FIGS. 5A and 5B are schematic plan views illustrating a light output faces of light guide plates according to the first embodiment;

FIGS. 6A to 6C are schematic cross-sectional views illustrating the light guide plates according to the first embodiment;

FIGS. 7A to 7C are schematic views illustrating local turning-on in the backlight according to the first embodiment;

FIGS. 8A to 9B are schematic plan views illustrating brightness distributions on the light emission face of the backlight according to the first embodiment;

FIGS. 10A to 10C are schematic diagrams illustrate a brightness distribution in the light emission face of the backlight according to the first embodiment;

FIGS. 11A and 11B are schematic views illustrating a backlight according to a second embodiment;

FIG. 12 is a schematic view illustrating a backlight according to a third embodiment;

FIG. 13 is a schematic diagram illustrating one example of a light emission pattern in the light emission face;

FIG. 14 is a schematic diagram illustrating another example of the light emission pattern on the light emission face.

### DETAILED DESCRIPTION

Embodiments of the present invention will be described below by referring to the attached drawings. The same portions in the drawings are given the same reference numerals, for which detailed description will be omitted as appropriate, and different portions will be described.

### First Embodiment

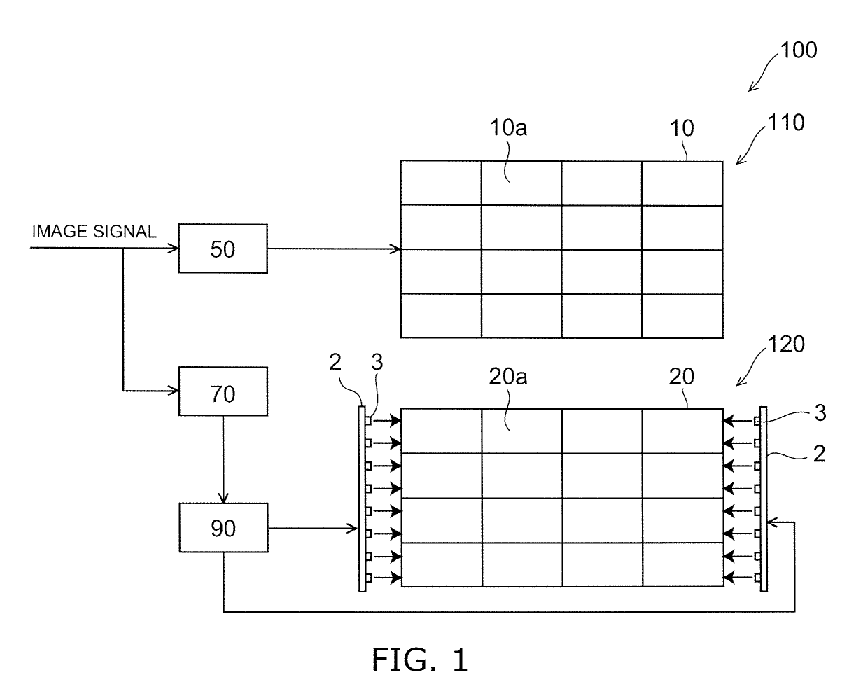

FIG. 1 is a schematic diagram illustrating the configuration of a liquid crystal display device 100 according to a first embodiment.

The liquid crystal display device 100 is provided with a liquid crystal panel 110 and a sidelight type backlight 120. In FIG. 1, the liquid crystal panel 110 and the backlight 120 are juxtaposed in illustration for convenience of description, but the liquid crystal panel 110 is arranged overlapping the backlight 120.

The liquid crystal display device 100 is provided, for example, with a signal conversion portion 50 that converts an image signal, input from the outside, into a control signal of the liquid crystal panel 110 and a dimming control portion 70 that extracts brightness information from the image signal. The liquid crystal panel 110 is driven by the control signal output from the signal conversion portion 50 and displays an image on a display screen 10 thereof. The dimming control portion 70 outputs a brightness signal that drives the backlight 120.

As illustrated in FIG. 1, the dimming signal output from the dimming control portion 70 is sent to a driving circuit 90. The driving circuit 90 turns on a plurality of light sources 3 on the basis of the dimming signal. The light sources are provided on light-source substrates 2 and arranged on both side faces of a light emission face 20 of the backlight 120.

In the backlight 120 according to the embodiment, the light sources 3 are grouped into a plurality of light-source groups. Each of the light-source group corresponds to any one of a plurality of light emission regions 20a in the light emission face 20. The light sources 3 may be individually turned on or turned on by each light-source group that includes at least one or more light sources 3. As a result, turning-off and turning-on can be controlled in each of the light emission regions 20a. Moreover, it is possible to control the brightness in each of the light emission region 20a by controlling light emission intensity of the light source 3.

On the other hand, the display screen 10 of the liquid crystal panel 110 arranged overlapping the backlight 120 includes a plurality of dimming regions 10a corresponding to each of the light emission regions 20a of the backlight 120. The dimming region 10a is capable of individual dimming by changing the brightness of the light emission region 20a. As a result, the contrast of the image in the display screen 10 can be improved beyond the limit of throttle of the liquid crystal panel. Also, in the light emission face 20 of the backlight 120, power consumption can be reduced, for example, by turning off the light emission region 20a corresponding to a dark part of the image or by controlling it to low brightness.

The dimming region 10a in the display screen 10 of the liquid crystal panel 110 is not a region obtained by physically dividing the display screen 10 but is defined as a region illuminated by each light emission region 20a of the backlight 120.

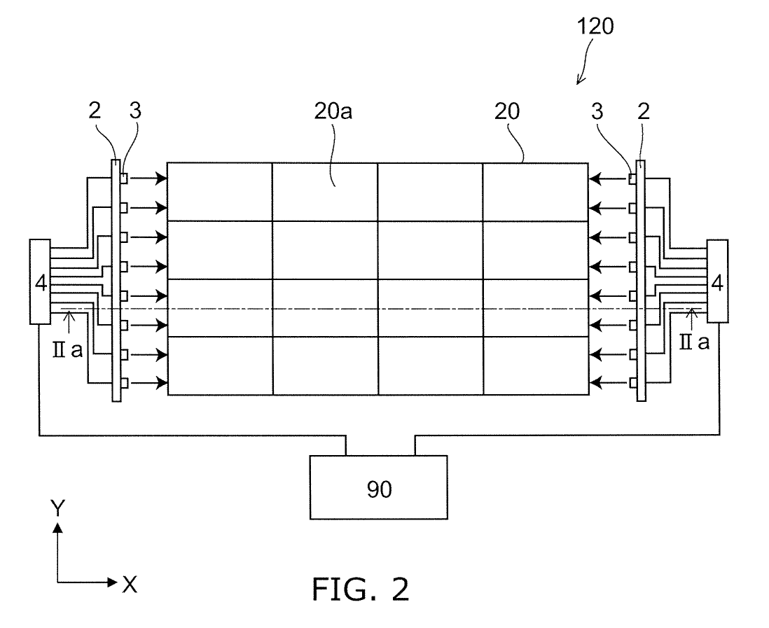

FIG. 2 is a plan diagram schematically illustrating the configuration of the backlight 120 according to the embodiment.

The backlight 120 is, as will be described later, provided with two light guide plates 12 and 13, which constitute a rectangular light emission face 20. The light guide plates 12 and 13 are arranged overlapping each other with the light radiation directions (Z directions) matched with each other. The light emission face 20 illustrated in FIG. 2 shows a state in which the light guide plates 12 and 13 arranged overlapping each other on plan view from the light radiation direction (the display screen side).

The backlight 120 is provided with the light-source substrates 2 arranged along two sides in the Y direction of the light emission face 20. A plurality of the light sources 3 are mounted and arranged on the light-source substrates 2. Moreover, the backlight 120 includes a turning-on circuit 4 that turns on the light sources 3 through interconnections included in the light-source substrate 2. A driving circuit 90 may also be included, which supplies a turning-on signal to the turning-on circuit 4. The turning-on circuit 4 selectively supplies a turning-on signal via the interconnections to at least one of light source groups, which include at least one of the light sources 3. Then, the light emission regions 20a emit light from the light sources 3 including in the light source group which receive the turning-on signal. Thereby, the turning-on/off control is performed in each of the light emission regions 20a.

The light source 3 is an LED, for example, and is controllably turned on by the turning-on signal sent to the turning-on circuit 4 from the driving circuit 90. The turning-on circuit 4 may supply power to the individual light sources 3 through a interconnection provided on the light-source substrate 2, for example, so as to turn them on. Then, the turning-on circuit 4 selects the light source 3 to be turned on in accordance with the turning-on signal of the driving circuit 90 and controls turning-on/turning-off through ON/OFF signal control. Moreover, it may be so configured that an electric current flowing through the LED is changed so as to change light emission intensity.

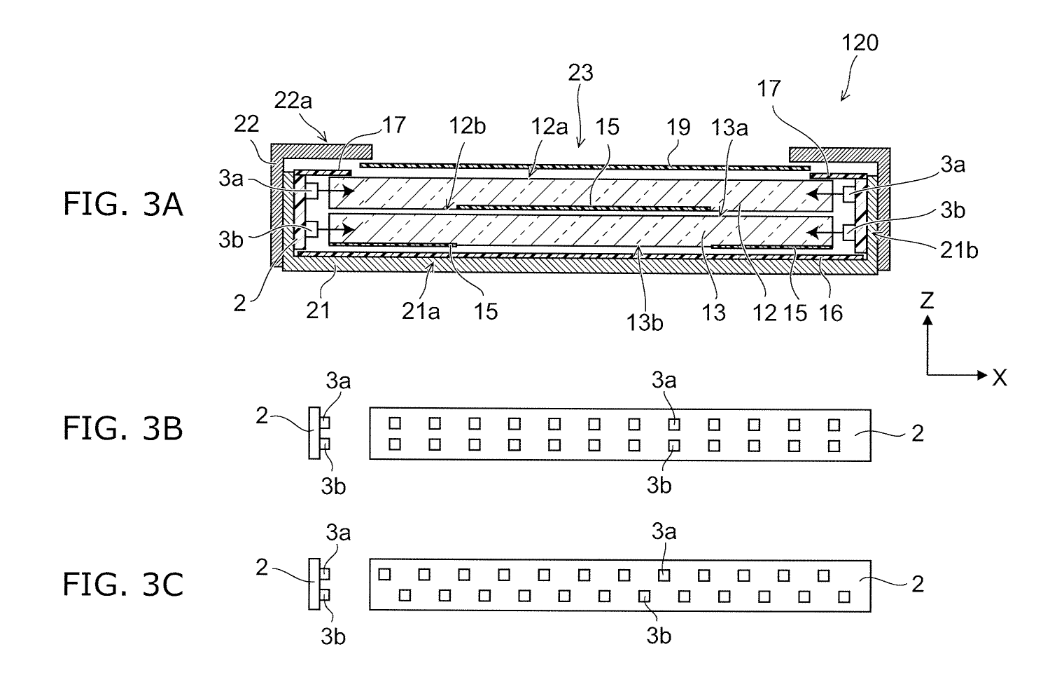

Subsequently, by referring to FIGS. 3A to 3C, the configuration of the backlight 120 will be described in detail.

FIG. 3A is a schematic view illustrating a IIa-IIa section of the backlight 120. The two light guide plates 12 and 13 are arranged overlapping each other in a state in which light output faces 12a and 13a thereof are directed in the Z direction where the liquid crystal panel 110 is arranged.

The light guide plates 12 and 13 may be made from transparent resins such as polymethylmethacrylate resin (PMMA) and cycloolefinpolymer resin (COP), polycarbonate resin (PC) and the like or glass, for example.

Moreover, light output patterns 15 are provided on a back face 12b of the light guide plate 12 and a back face 13b of the light guide plate 13. The light output pattern 15 changes the light propagation direction along the light output faces 12a and 13a to the direction of the display screen 10 (Z direction). The light output pattern 15 is provided on a part of the back faces of the light guide plates 12 and 13, which becomes a high brightness region where light is emitted with relatively high brightness.

The light output patterns 15 can be formed by using printing method, laser processing and the like, for example. The pattern can be provided in the shape of dots, grained pattern, full-reflection/refraction pattern and the like.

The light output patterns 15 are not limited to form on the back-face sides of the light guide plates 12 and 13. It may be possible to form on the light emission face sides.

The light guide plates 12 and 13 are contained in a tray-shaped back frame 21 having an opening 23 on the upper face in the Z direction. The light output face 12a of the light guide plate 12 and the light output face 13a of the light guide plate 13 are arranged in the direction of the opening 23 (Z direction) with the back-face sides thereof directed to a bottom face 21a of the back frame 21. The light-source substrate 2 provided with the light sources 3 is attached on a side face 21b of the back frame 21.

FIGS. 3B and 3C illustrate examples of planar arrangement of the light sources 3 on the light-source substrate 2 when seen from the sides of the light guide plates 12 and 13. For example, as illustrated in FIGS. 3B and 3C, the light sources 3 can be arranged in two vertical rows in the longitudinal direction of the light-source substrate 2.

As indicated by arrows in FIG. 3A, light emitted from the light sources 3a arranged on the upper row enters the light guide plate 12 and propagates in the direction along the output face 12a. On the other hand, the light of the light sources 3b arranged on the lower row enters the light guide plate 13 and propagates in the direction along the light output face 13a.

The light sources 3a and 3b can be arranged such that when the light emitted from the light sources 3a and 3b are made to enter the respective side faces of the light guide plates 12 and 13, for example, the emitted light enters the center of the width in the thickness direction (Z direction) of the light guide plates.

As illustrated in FIG. 3B, the positions of the light sources 3a and 3b in the Z direction may be aligned with equal intervals or as illustrated in FIG. 3C, the phases of the alignment cycle of the light sources 3a and the alignment cycle of the light sources 3b may be shifted in a staggered manner.

In the staggered arrangement illustrated in FIG. 3C, since the light sources 3, which are heat generating bodies, are uniformly dispersed on the surface of the light-source substrate 2, a mutual influence of the heat generation can be suppressed between the light sources 3. That is, the temperature of the light sources 3 during operation can be lowered, and if the light sources 3 are LED, for example, light emission efficiency can be improved and power consumption can be reduced, and moreover, the life of LED can be prolonged.

In the backlight 120 according to the embodiment, as illustrated in FIG. 2, the light sources 3 are arranged on the two side faces opposing each other among the four side faces of the light guide plates 12 and 13 overlapped each other.

As illustrated in FIG. 3A, the light-source substrates 2 with the light sources 3 are attached to the two side walls 21b opposing each other in the back frame 21. The optical axes of the light sources 3 are arranged orthogonal to the side faces of the light guide plates 12 and 13 opposing the side wall 21b.

Then, as illustrated in FIGS. 3A and 3B, the light sources 3a and 3b attached to the one side wall 21b are mounted on the same light-source substrate 2. As a result, the positional relationship between the light sources 3a and 3b is fixed; the number of components is reduced; and it becomes possible to improve work efficiency in the assembling process of the backlight 120.

The light-source substrate 2 may include a plurality of the interconnections, for example. The turning-on circuit 4 may also be provided on the light-source substrate 2 in addition to the light sources 3a and 3b.

The opening side of the back frame 21 is covered by a front frame 22, and the light guide plates 12 and 13 are fixed to the inside of the back frame 21.

A reflection sheet 16 is arranged between the back face 13b of the light guide plate 13 and the bottom face 21a of the back frame 21. Moreover, a reflection sheet 17 is arranged also between the light guide plate 12 and a frame 22a on the side of an opening 23 of the front frame 22.

By means of the reflection sheet 16, the light leaking to the back face side of the light guide plate 13 is reflected to the direction of the opening 23, while by means of the reflection sheet 17, the light not entering the light guide plates 12 and 13 but leaking upward is returned to the light guide plates 12 and 13 so that brightness in the light output faces 12a and 13a and flatness in brightness distribution are improved.

Ann optical sheet 19 is arranged on the light output face 12a of the light guide plate 12. With regard to the optical sheet 19, a plurality of the optical sheets such as a diffusion sheet, a polarization plate and the like may be provided in combination in order to adjust brightness, a view angle, and polarization to a desired state in the display screen 10 of the liquid crystal panel 110.

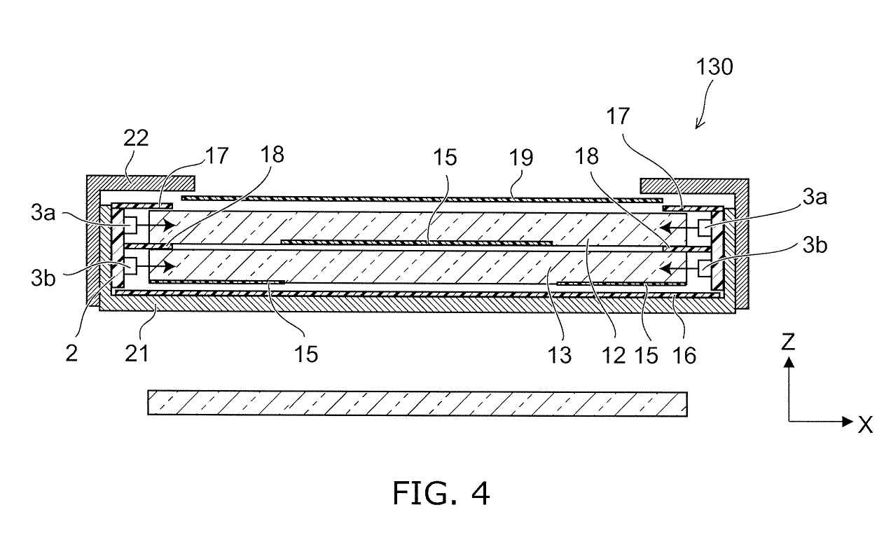

FIG. 4 is a schematic cross-sectional view illustrating a backlight 130 according to a variation of the embodiment.

The backlight 130 has a point in common with the backlight 120 illustrated in FIGS. 3A to 3C that the light guide plate 12 and the light guide plate 13 are arranged overlapping each other in the Z direction and the light sources 3a and 3b are arranged on the side faces opposing each other of the light guide plates 12 and 13.

On the other hand, the backlight 130 according to the variation is different from the backlight 120 in a point that a reflection sheet 18, which is a reflection member that works as a shield, is further provided between the light source 3a arranged on the light guide plate 12 and the light source 3b arranged on the light guide plate 13.

As illustrated in FIG. 4, the reflection sheet 18 is provided so as to extend from the light-source substrate 2 into a gap between the light guide plate 12 and the light guide plate 13. The reflection sheet 18 shields the light propagating in the direction of the light guide plate 12 in the light emitted from the light source 3b and shields the light emitted from the light source 3a and propagating in the direction of the light guide plate 13. As a result, stray light incident to each of the light guide plates 12 and 13 is suppressed, and contrast can be improved if the light emission region 20a (See FIG. 2) is individually turned on so as to perform local dimming.

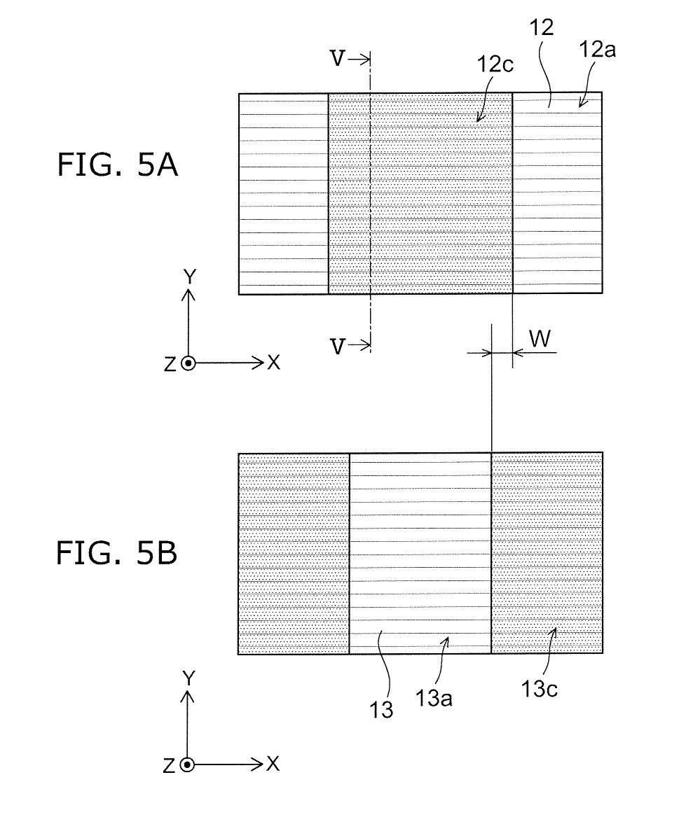

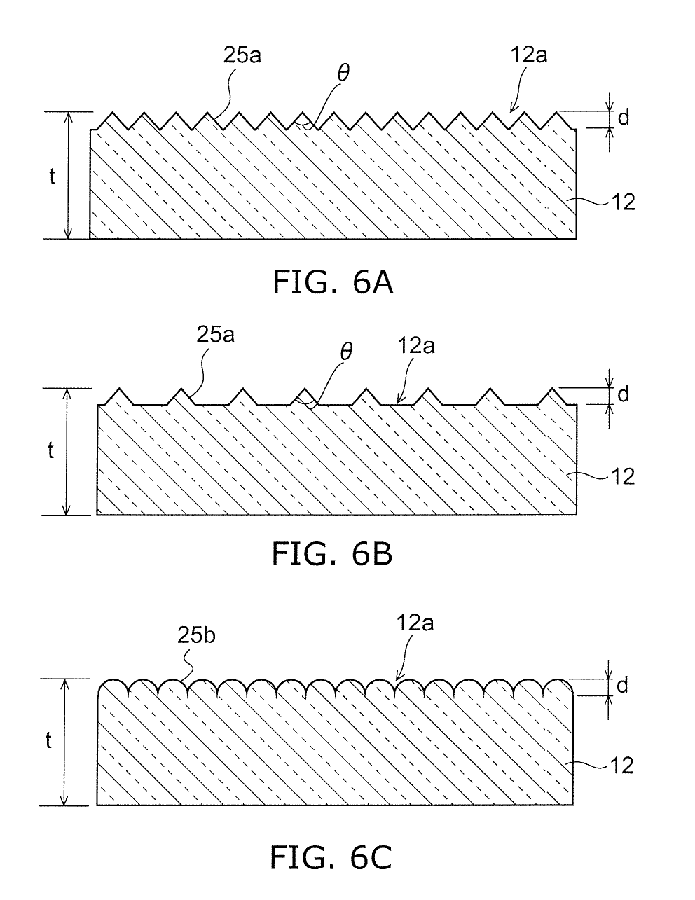

Subsequently, by referring to FIGS. 5A to 6C, the light guide plates 12 and 13 according to the embodiment will be described.

FIGS. 5A and 5B are plan views schematically illustrating the light output face 12a of the light guide plate 12 and the light output face 13a of the light guide plate 13 according to the embodiment.

As illustrated in FIG. 3A, in the light guide plate 12, the light output pattern 15 is provided at the center of the back face 12b. Then, as illustrated in FIG. 5A, a high brightness region 12c is formed at the center of the light output face 12a corresponding to the light output pattern 15.

The light emitted from the light sources 3a (See FIGS. 3A to 3C) arranged on the short side of the light guide plate 12 propagates in the X direction along the long side, and the propagation direction is changed by the light output pattern 15 provided on the high brightness region 12c. Then, the light is emitted to the Z direction, which is a direction in which the display screen 10 is arranged. Thus, the high brightness region 12c on which the light output pattern 15 is provided emits light with brightness higher than that of the other regions in the light output face 12a where the light output pattern 15 is not provided.

On the other hand, as illustrated in FIG. 3A, in the light guide plate 13, the light output pattern 15 is provided on the both ends of the back face 13b of the light guide plate 13. Then, as illustrated in FIG. 5B, a high brightness region 13c is formed on the both ends of the light output face 13a corresponding to the light output pattern 15.

As illustrated in FIGS. 5A and 5B, the light output pattern 15 is provided in the band shape extending in the Y direction orthogonal to the propagation direction of the light emitted from the light sources 3. Then, if the light guide plates 12 and 13 are arranged overlapping each other, they can be provided so that the high brightness region 12c and the high brightness region 13c cover the entirety of the light emission face 20 (See FIG. 2) on plan view from the display screen side (Z direction).

Moreover, on the boundary between the high brightness region 12c and the high brightness region 13c, an overlapping region W is formed where the periphery portion of the high brightness region 12c and the periphery portion of the high brightness region 13c overlap each other. As a result, a dark line or a bright line in the boundary portion is suppressed, which might occur if the overlapping region W is not provided, and an image quality displayed on the boundary portion can be improved.

The image quality can be also improved by gradually changing the pattern depth, density or the like of the light output pattern 15 from the center part side toward the ends in the periphery of the respective high brightness regions.

FIGS. 6A to 6C are schematic cross-sectional views exemplifying the light guide plate 12, taking along a V-V line shown in FIG. 5A.

In the backlights 120 and 130 according to the embodiment, a plurality of stripe-shaped projections 25 can be provided on the light emission faces of the light guide pates 12 and 13. The projections 25 are formed so as to extend along the propagation direction of the light emitted from the light sources 3.

For example, as illustrated in FIG. 6A, projections 25a, each of which has a triangular section, can be formed so as to be aligned along the surface of the light output face 12a.

As illustrated in FIG. 6B, flat regions may be provided between the triangular projections 25a. Moreover, as illustrated in FIG. 6C, the shape may be so-called lenticular including an arc in the section.

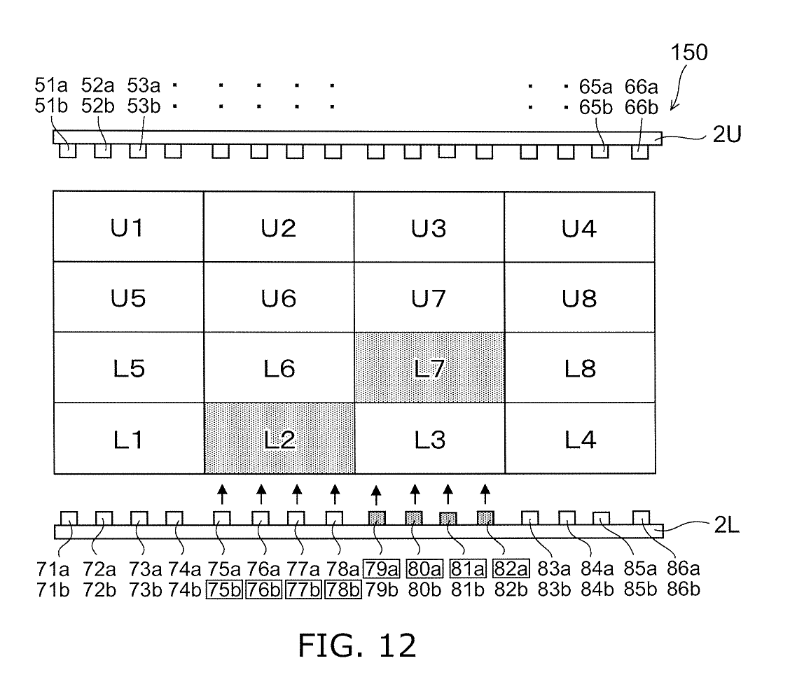

FIG. 13 is a schematic diagram illustrating an example of a light emission pattern on the light emission face, when the light is made to enter the light guide plate from the one light source 3. In this case, the projections 25 are not provided on the surface of the light emission face, but the light output pattern 15 is provided on the whole back face of the light guide plate. I₁ to I₇ are isophotes, respectively, and indicate brightness that becomes higher in the order from I₁ to 1₇.

In the light emission pattern illustrated in FIG. 13, the brightness becomes lower from the end of the light guide plate to the center.

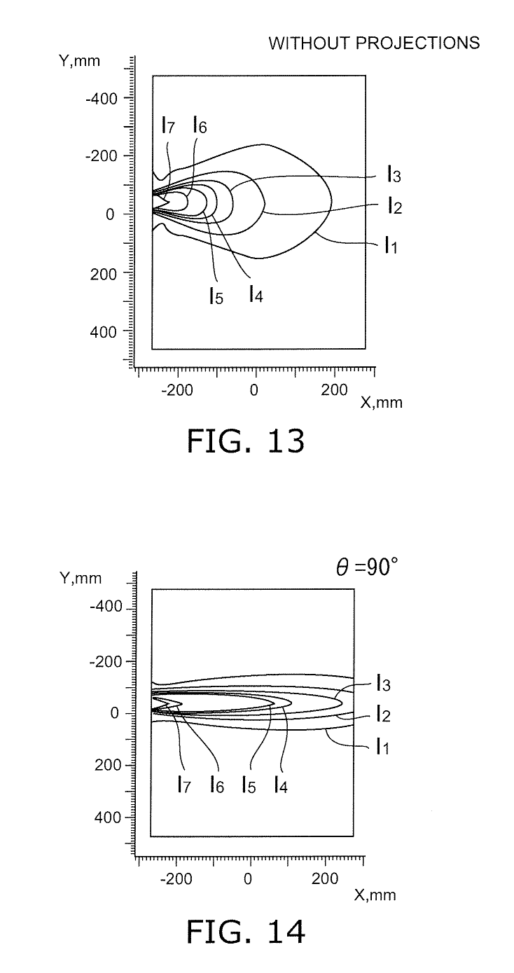

On the other hand, in the example illustrated in FIG. 14, the triangular projections 25a illustrated in FIG. 6A are provided on the light output face of the light guide plate. As compared with the light emission pattern illustrated in FIG. 13, it is known that the width in the Y direction becomes narrower and the region with high brightness expands toward the center of the light guide plate. That is, by providing the projections 25a, a change in brightness in the Y direction in FIG. 13 becomes sharper, and a boundary between the light emission portion and a non-light emission portion becomes clearer. And the light emitted from the light sources 3 can be propagated farther.

In an example illustrated in FIG. 14, the apex angle θ of the triangular projection 25a provided on the light output face is 90°. By widening the apex angle θ, the shape of the light emission pattern changes from the light emission pattern illustrated in FIG. 14 to the light emission pattern shape illustrated in FIG. 13. That is, the width in the Y direction becomes wider, and the distance for which the light incident from the end face of the light guide plate propagates in the X direction becomes shorter.

On the other hand, if the apex angle θ is made smaller than 90°, a pattern can be realized that the width in the Y direction is smaller than that in the light emission pattern illustrated in FIG. 14 and the region with high brightness extends in the X direction. Moreover, by changing a height d of the projection 25a and by changing a ratio between the height d and a thickness t of the light guide plate (d/t), the light emission pattern can be also adjusted to a desired shape.

By providing the stripe-shaped projections on the light output face of the light guide plate as above, the light emission pattern of the light emitted from the light sources 3 can be changed. That is, the light emission pattern can be adjusted in accordance with the position and size of the light emission region in the light emission face. By combining the incident position of the light which can be changed by selection of the light sources 3 and the light output pattern provided selectively on the light guide plate, for example, light emission of an arbitrary region in the light emission face becomes possible. As a result, local dimming can be realized using the sidelight type backlight.

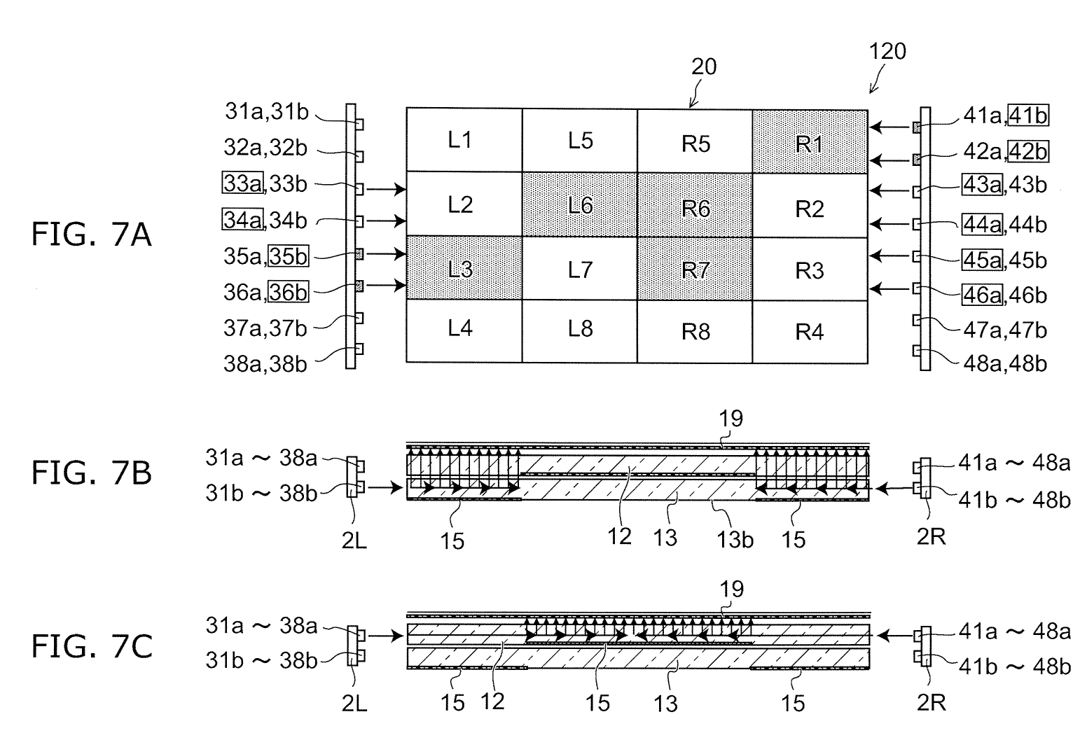

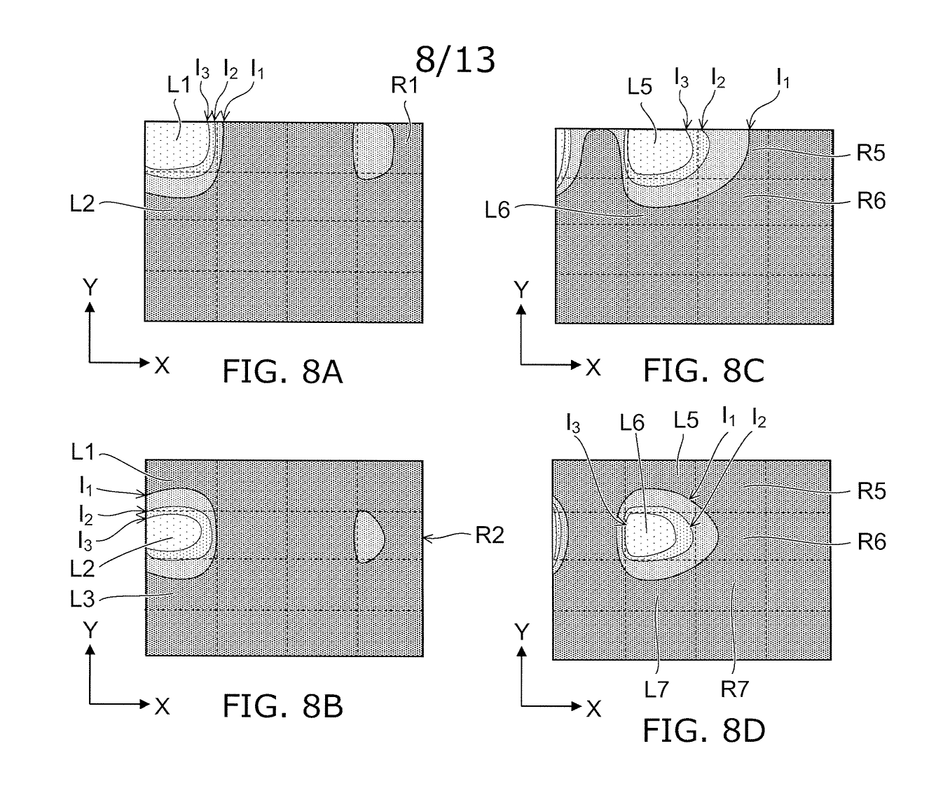

Subsequently, by referring to FIGS. 7A to 9B, a method of local dimming in the backlight 120 according to the embodiment will be described. FIGS. 7A to 7C are schematic views for describing local turning-on in the backlight 120. FIGS. 8A to 9B are schematic diagrams illustrating examples in which the backlight 120 is turned on.

As illustrated in FIG. 7A, light emission regions L1 to L8 and light emission regions R1 to R8 are provided on the light emission face 20 of the backlight 120. Light sources 31 to 38 and light sources 41 to 48, which make the respective regions emit light, are arranged along the two opposing short sides of the light emission face 20. Moreover, the light sources are arranged in two lines denoted by a and b, and each emits light incident to the light guide plates 12 and 13.

As illustrated in FIGS. 7B and 7C, in the backlight 120, the light guide plate 12 and the light guide plate 13 are arranged overlapping each other. The light emission face 20 illustrated in FIG. 7A is a light emission face of the backlight 120 on plan view seen from the display screen side and includes both the light emission regions included in the light output face 12a of the light guide plate 12 and the light emission regions included in the light output face 13a of the light guide plate 13.

Light sources 31a to 38a on the left side face of the light emission face 20 are arranged on the upper side of a light-source substrate 2L and light sources 31b to 38b are arranged on the lower side, respectively, and emit light toward the light guide plates 12 and 13. The light output pattern 15 corresponding to the light emission regions L1 to L4 are provided on the back face 13b of the light guide plate 13, while the light output pattern 15 corresponding to the light emission regions L5 to L8 are provided on the back face 12b of the light guide plate 12.

On the other hand, the light sources 41a to 48a on the right side face of the light emission face are arranged on the upper side of a light-source substrate 2R and the light sources 41b to 48b are arranged on the lower side, respectively, and emit light toward the light guide plates 12 and 13. The light output pattern 15 corresponding to the light emission regions R1 to R4 is provided on the back face 13b of the light guide plate 13, while the light output pattern 15 corresponding to the light emission regions R5 to R8 is provided on the back face 12b of the light guide plate 12.

For example, as illustrated in FIG. 7B, when the light sources 35b and 36b on the lower side of the light-source substrate 2L are turned on as one light source group, the emitted light enters the light guide plate 13. The emitted light has the propagation direction thereof changed by the light output pattern 15 provided on the back face 13b of the light guide plate 13 and propagates in the direction of the light emission face 20 (the direction of the optical sheet 19) so as to make the light emission region L3 emit light. Similarly, when, the light sources 41b and 42b on the lower side of the light-source substrate 2R are turned on, the light emission region R1 emits light.

Also, in order to selectively control light emission in the light emission region L6, as illustrated in FIG. 7C, the light sources 33a and 34a on the upper side of the light-source substrate 2L are turned on as one light source group. Moreover, in order to selectively control light emission in the light emission regions R6 and R7, the light sources 43a and 44a and the light sources 45a and 46a, which are adjacent two light source groups, on the upper side of the light-source substrate 2R are turned on.

As described above, in the backlight 120, by individually turning on the light source groups arranged on the both sides of the light emission face 20, a desired region can be made to emit light.

At this time, the stripe-shaped projections 25a are adjusted on the surface of the light guide plate 12, in order to suppress the light emitted from the light sources 33a and 34a in the light emission region R6. That is, the projections 25a provided on the surface of the light guide plate 12 are provided so that the emitted light from one light source group of the light sources 33a and 34a propagates beyond the light emission region L2 and sufficient brightness can be obtained in the light emission region L6. Furthermore, the values of the apex angle θ and d/h are adjusted, for example, so that the bright region does not extend to the light emission region R6.

As described above, in the backlight 120 according to the embodiment, the 16 light emission regions (L1 to L8 and R1 to R8) can be individually made to emit light by turning on the corresponding light sources in the 16 light sources (31 to 38 and 41 to 48).

FIGS. 8A to 10C are plan diagrams illustrating brightness distributions on the light emission face 20 as the turned-on examples of the backlight 120.

FIGS. 8A and 8B indicate brightness distribution when the light emission regions L1, L2, L5, and L6 are made to emit light, respectively. The isophotes I₁, I₂ and I₃ illustrated in the figure indicate brightness levels increasing in this order.

When the light emission region L1 emits light as illustrated in FIG. 8A, the light sources 31b and 32b are turned on, and the emitted light propagates in the X direction through the light guide plate 13. The light output pattern 15 changes the light propagation direction, which are provided on the both ends of the back face 13b of the light guide plate 13, and thereby the light mission regions L1 and R1 emit light. The light emission region L1 emits light at predetermined brightness (I₂) or more, while the brightness of the light emission region R1 is I₂ or less. Furthermore, the projections 25a provided on the light output face 13a of the light guide plate 13 suppresses the light expansion in the Y direction, and thereby the brightness of the light emission region L2 adjacent to the light emission region L1 is also kept low.

As illustrated in FIG. 8B, the light emission region L2 emits light at the brightness of I₂ or more, while the brightness of the light emission regions R2 and the light emission regions L1 and L3 adjacent thereto is suppressed to I₂ or less.

When the light emission region L5 emits light as illustrated in FIG. 8C, the light sources 31a and 32a are turned on. The light emitted from the light sources 31a and 32a propagates in the X direction through the light guide plate 12, the propagation direction thereof is changed by the light output pattern 15 provided at the center on the back face 12b of the light guide plate 12, and the light emission region L5 is made to emit light. Since the light output pattern 15 is also provided on the light emission regions L6 adjacent to the light emission region L5, R5 and R6, the light emission is seen in the adjacent regions continuously expanding from the light emission region L5, but the brightness is kept to I₂ or less.

As illustrated in FIG. 8D, the light emission region L6 emits light at the brightness of I₂ or more, but the light emission of the adjacent light emission regions L5, L7 and R5, R6, and R7 is kept to I₂ or less.

FIGS. 9A and 9B illustrate an example where the light emission face 20 emits light in the band shape by turning on a plurality of light sources.

In the example illustrated in FIG. 9A, the light sources 31a, 32a, 31b, 32b, 41a, 42a, 41b, and 42b are turned on so as to make the light emission regions L1, L5, R1 and R5 emit light. As illustrated in the same figure, the light emission regions L1, L5, R1, and R5 emit light uniformly in the band shape at the brightness of I₂ or more. The brightness of the adjacent light emission regions L2, L6, R2, and R6 is suppressed to I₂ or less.

In an example illustrated in FIG. 9B, the light emission regions L2, L6, R2, and R6 emit light uniformly at the brightness of I₂ or more, while the brightness of the adjacent light emission regions L1, L5, R1, and R5 and the light emission regions L3, L7, R3, and R7 is suppressed to I₂ or less.

The band-shaped light mission illustrated in FIGS. 9A and 9B indicates an effect of the stripe-shaped projections 25a provided on the surface of the light guide plates 12 and 13. That is, expansion of the emitted light in the Y direction is suppressed in the light guide plates 12 and 13, and each light emission region corresponding to the turned-on light source is made to emit light at high brightness.

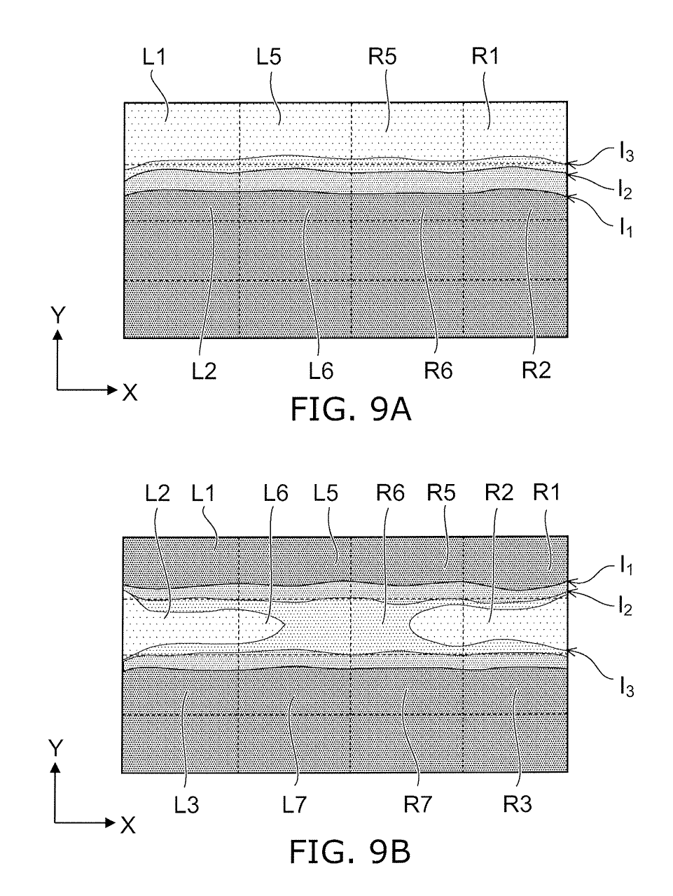

FIGS. 10A to 10C illustrate brightness distribution of the light emission face 20, when all the light sources of the backlight 120 are turned on.

FIG. 10A is a plan diagram illustrating brightness distribution of the light emission face 20. Light is emitted uniformly and a dark line or a bright line indicating a boundary between each light emission region is not found in the light emission face 20.

FIG. 10B is a graph illustrating brightness along an Xb-Xb line shown in FIG. 10A. The brightness is higher in the vicinity of the right and left sides of the light emission face where the light sources are arranged, but uneven brightness is suppressed at the center of the light emission face.

FIG. 10C is a graph illustrating brightness along an Xc-Xc line shown in FIG. 10A. It exhibits a distribution in which the brightness is higher at the center of the light emission face, while the brightness is lower in the vicinity of the upper and lower sides.

When the liquid crystal display device 100 is to be used as a monitor for a TV or a computer, a uniformity ratio is required to be 0.5 or more. For example, the uniformity ratio of brightness in the display screen can be expressed as follows:

Uniformity ratio=1−(maximum brightness−minimum brightness)/maximum brightness

The uniformity ratio is 0.5 or more in the brightness distribution of the light emission face 20 illustrated in FIGS. 9A and 9B, i.e. brightness distribution shown is sufficient for the backlight of the liquid crystal display device 100.

As described above, in the backlight 120 according to the embodiment, the 16 light emission regions included in the light emission face 20 can be individually made to emit light by individually turning on the light sources arranged on the two sides of the light emission face 20. Therefore, the local dimming can be performed in the liquid crystal display device 100 using the backlight 120, and may realizes reduction of power consumption and improvement of light contrast.

In the example in FIGS. 7A to 7C, the configuration is illustrated in which the light source group of the two light sources makes the one light emission region emit light, but alternatively, it may be a configuration in which a light source group including one or three or more light sources makes one light emission region emit light.

### Second Embodiment

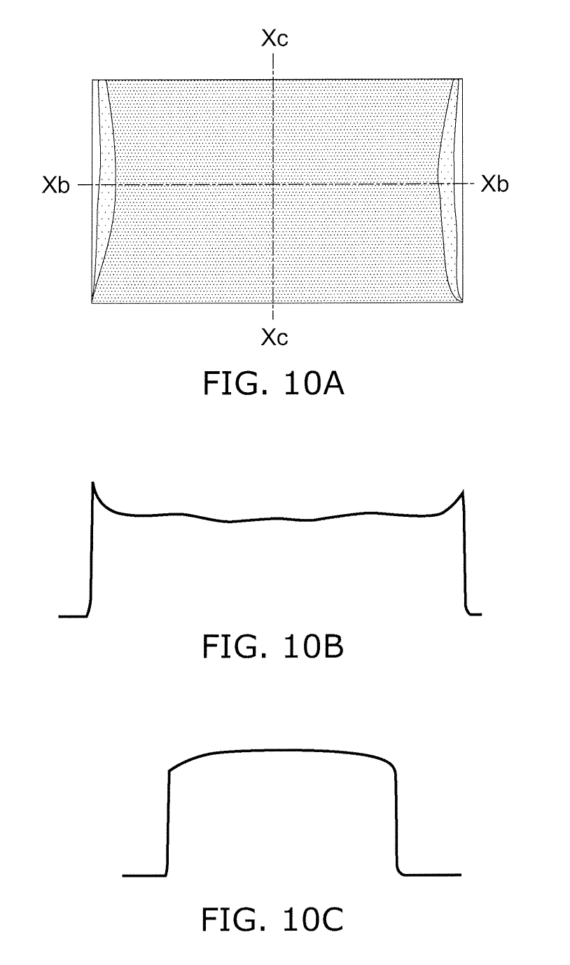

FIGS. 11A and 11B are schematic views illustrating a backlight 140 according to a second embodiment.

As illustrated in FIG. 11A, in the backlight 140 according to the embodiment, the light emission face 30 is divided into six parts in the X direction and four parts in the Y direction and includes 24 light emission regions 30a.

FIG. 11B schematically illustrates a sectional structure of the backlight 140. As illustrated in FIG. 11B, three light guide plates 12, 13, and 14 are arranged overlapping with each other, and the light output pattern 15 is provided on the back faces 12b, 13b, and 14b of the respective light guide plates.

In the embodiment, the light output pattern 15 is provided at the center of the back face 12b of the light guide plate 12 arranged on the uppermost stage, and the light output pattern 15 is provided on the both ends of the back face 14b of the light guide plate 14 arranged on the lowermost stage. On the back face of the light guide plate 13 arranged between the light guide plate 12 and the light guide plate 14, the light output pattern 15 is provided between the center and the ends. As a result, they can correspond to the six light emission regions divided in the X direction.

On the other hand, the light sources 3 are provided in alignment of three stages in the Z direction in order to make the emitted light incident to each of the light guide plates 12, 13, and 14. For example, assuming that two light sources are arranged in one light emission region, 24 light sources 3a, 3b, and 3c are arranged on one side in the Y direction divided into four parts.

By means of the above configuration, it is possible to configure the backlight 140 including 24 light emission regions. In order to increase the number of light emission regions included in the light emission face, it is only necessary to increase the number of light guide plates and the number of light sources arranged on the side face of the light guide plate and to segmentalize the light emission face.

Moreover, fine dimming of each light emission region can be performed by changing the brightness of the light sources 3, in addition to the pattern of turning-on and non-turning-on. For example, if the light sources 3 are LED, by changing a current flowing through the LED, the brightness can be continuously changed. As a result, local dimming can be performed, which loyally reflects brightness information of the input image signal.

### Third Embodiment

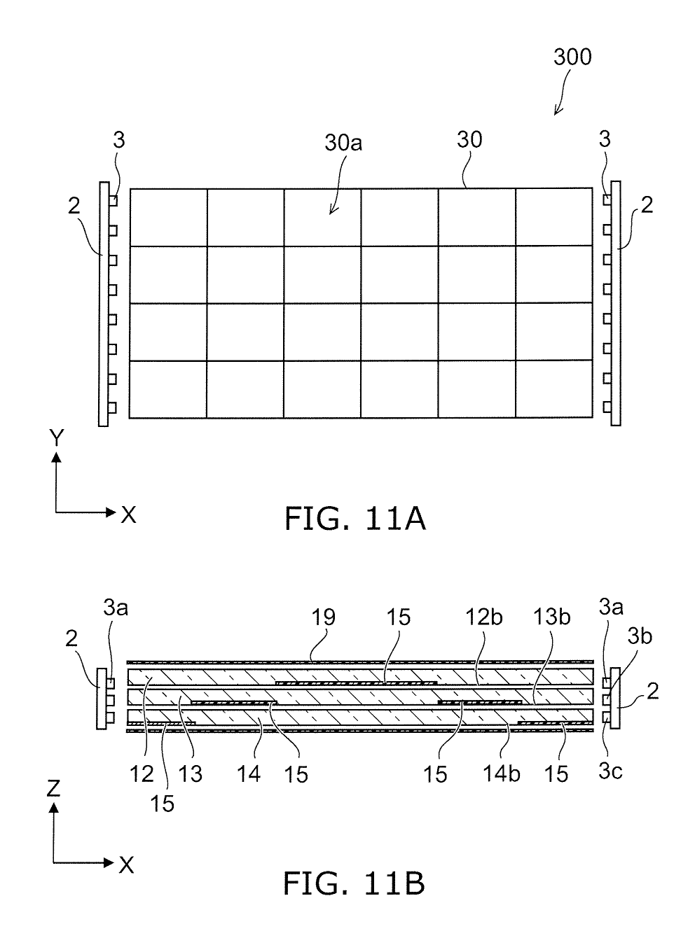

FIG. 12 is a schematic diagram illustrating a backlight 150 according to the embodiment. The backlight 150 is different from the backlight 120 according to the first embodiment in a point that light sources 51 to 66 and 71 to 86 are arranged along the long sides of the light guide plates 12 and 13.

The light sources 51 to 66 are arranged in vertical two stages attached with suffixes a and b in a light-source substrate 2U arranged on the upper side and emit light incident to the light guide plates 12 and 13, respectively. The light sources 71 to 86 are arranged in vertical two stages attached with suffixes a and b in a light-source substrate 2L arranged on the lower side.

As illustrated in FIG. 12, the light emission face of the backlight 150 has 16 light emission regions U1 to U8 and L1 to L8. The light emission regions U1 to U8 can be made to emit light, respectively, by individually turning on the light source group including four light sources in the light sources 51 to 66 arranged on the upper side. Similarly, the light emission regions L1 to L8 can be also made to emit light by individually turning on the light source group included in the light sources 71 to 86 arranged on the lower side.

For example, the light output pattern 15 is provided on the back face 13b of the light guide plate 13 corresponding to the light emission regions U1 to U4 and L1 to L4. On the other hand, the light output pattern 15 is also provided on the back face 12b of the light guide plate 12 corresponding to the light emission regions U5 to U8 and L5 to L8 (See FIGS. 7A to 7C).

As illustrated in FIG. 12, the light emission region L2 can be made to emit light by turning on the light source group including the four light sources 75b to 78b mounted and arranged on the light-source substrate 2L, and the light emission region L7 can be made to emit light by turning on the light source group including the light sources 79a to 82a.

As described above, the light sources 3 can be arranged along the long sides of the rectangular light guide plates 12 and 13.

In the liquid crystal display device and the backlight thereof described in the first to third embodiments above, the plurality of dimming regions are included in the display screen of the liquid crystal display device, and the respective light output faces of the plurality of light guide plates provided in the backlight have a light emission region corresponding to at least any one of the dimming regions of the display screen. Each of the dimming regions corresponds to at least any one of the light emission regions included in the light guide plates.

By providing the light emission regions, which divide the whole light emission face of the backlight into plural parts, the whole face of the display screen can be covered by the plurality of corresponding dimming regions.

Each of the light emission regions corresponds to any of the plurality of light sources arranged on the side face of the light guide plate and emits light by turning on the light source. As a result, turning-on of the individual light sources can be controlled and local dimming which locally dims the display screen can be performed in the sidelight type backlight. Then, a liquid crystal display device can be realized with low power consumption and improved contrast.

The present invention has been described above by referring to the first to third embodiments according to the present invention, but the present invention is not limited by these embodiments. For example, embodiments having the same technical idea as the present invention such as design changes that can be made by those skilled in the art on the basis of the technical standards at the time of filing, change of the material and the like are also included in the technical scope of the present invention.

What is claimed is:

1. A backlight device comprising:
a plurality of light guide plates overlapping each other with a same light output direction, each of the light guide plates including a plurality of stripe-shaped projections aligned on a light output face and a light output pattern making a part of the light output face emit light at relatively high brightness;
a plurality of light sources, each emitting light incident into any one of the plurality of light guide plates and propagating in an extending direction of the stripe-shaped projections; and
a light-source substrate including a plurality of interconnections, a turning-on signal being selectively supplied via the interconnections to at least one of light source groups, each of the light source groups including at least one of the light sources,
and at least one part of a light emission face emitting light output from the light source group receiving the turning-on signal, the light emission face including the light output faces overlapped on plan view from the light output direction.

2. The device according to claim 1, further comprising:
a driving circuit supplying the turning-on signal; and
a turning-on circuit turning on the light source when receiving the turning-on signal from the driving circuit.

3. The device according to claim 2, wherein
the turning-on circuit executes on/off control of the light source by the turning-on signal.

4. The device according to claim 2, wherein
the turning-on circuit changes light emission intensity of the light source by the turning-on signal.

5. The device according to claim 1, wherein
each of the light guide plates includes the light output face having a rectangular shape; and
the light sources are arranged along one side of the light output face and the side opposing the one side in each of the light guide plates.

6. The device according to claim 1, further comprising:
a reflection member provided as a shield between the light sources arranged on one of the light guide plates and the light sources arranged on the other light guide plates,
wherein the reflection member suppresses light incident to the one of the light guide plates from the light source arranged on the other of the light guide plates.

7. The device according to claim 1, wherein
the light emission face includes a plurality of light emission regions covering the whole face; and
each of the light emission regions emits light output from any one of the light guide plates.

8. The device according to claim 7, wherein
turning-off and turning-on in the light emission region is controlled by the light source group corresponding to each of the light emission regions.

9. The device according to claim 7, wherein
brightness in the light emission region is controlled by light emission intensity of the light source group corresponding to each of the light emission regions.

10. The device according to claim 1, wherein
the light sources are arranged in plural rows juxtaposed in the longitudinal direction of the light-source substrate.

11. The device according to claim 10, wherein
the light sources are arranged at equal intervals in the longitudinal direction and arranged with the matched positions in the lateral direction of the light-source substrate.

12. The device according to claim 10, wherein
the light sources are arranged with equal intervals in the longitudinal direction and one of the two rows is arranged with a shift of a half cycle.

13. The device according to claim 1, wherein
the light sources emitting light incident to a plurality of the light guide plates are mounted on the same light-source substrate.

14. The device according to claim 1, wherein
the optical axis of the light source is orthogonal to the side face of the light guide plate.

15. The device according to claim 1, wherein
the light output pattern is provided in the band shape extending in a direction crossing the propagation direction of light emitted from the light source.

16. The device according to claim 1, wherein
the light output patterns provided on the different light guide plates and adjacent to each other are overlapped in the boundary thereof on plan view in parallel with the light emission face.

17. The device according to claim 1, wherein
the light output pattern is one of dotted pattern, grained pattern or full reflection and refraction pattern.

18. The device according to claim 1, wherein
the stripe-shaped projection has one of a triangular section and a section including an arc.

19. A liquid crystal display device comprising:
a backlight comprising:
a plurality of light guide plates overlapping each other with a same light output direction, each of the light guide plates including a plurality of stripe-shaped projections aligned on a light output face and a light output pattern making a part of the light output face emit light at relatively high brightness;
a plurality of light sources, each emitting light incident into any one of the plurality of light guide plates and propagating in an extending direction of the stripe-shaped projections; and
a light-source substrate including a plurality of interconnections, a turning-on signal being selectively supplied via the interconnections to at least one of light source groups, each of the light source groups including at least one of the light sources, and and at least one part of a light emission face emitting light output from the light source group receiving the turning-on signal, the light emission face including the light output faces overlapped on plan view from the light output direction.

20. The device according to claim 19, further comprising:
a liquid crystal panel illuminated with the backlight, wherein
a part of the light emission face is controlled to be turned off or to low brightness corresponding to a dark part of an image displayed on the liquid crystal panel.
